(19) United States
(12) Patent Application Publication
(10) Pub. No.: US 2010/0214567 A1
(43) Pub. Date: Aug. 26, 2010

(54) Nanoparticle Based Identification

(76) Inventor: Artem Shtatnov, Newtown, PA (US)

Correspondence Address: Artem Shtatnov, 154 Jericho Valley Drive, Newtown, PA, 18940, US

(21) Appl. No.: 12/418,584

(22) Filed: Apr. 4, 2009

Related U.S. Application Data
(60) Provisional application No. 61/042,723, filed on Apr. 5, 2008.

(51) Int. Cl. G01N 21/00

(52) U.S. Cl. 356/432

(57) ABSTRACT

This patent application asserts application of a spot-mixture of nanoparticles in barcoding of information for security and protection. ID encoding and subsequent readout is made using the distinctive spectral features of the spot-mixture of nanoparticles defined as a tiny, invisible spots made up of absorbing and fluorescent nanoparticles whose spectral properties will be used for security ID signatures.

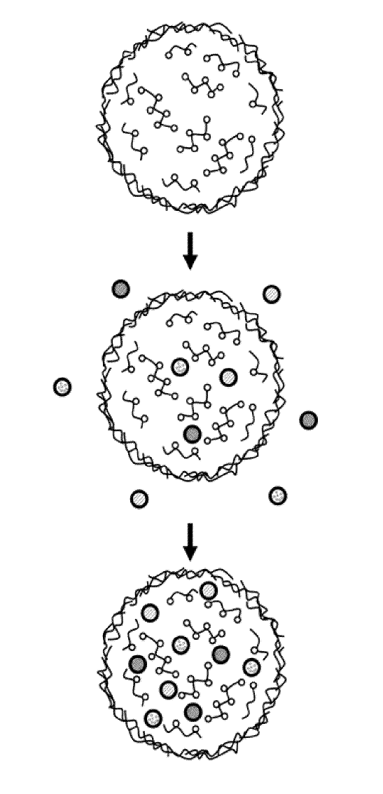

### BRIEF DESCRIPTION OF THE DRAWING

A unique spot-mixture of nanoparticles is deposited into the material. ID encoding and subsequent readout is made using the distinctive spectral features of the spot-mixture of nanoparticles in the material.

### DETAILED DESCRIPTION OF THE INVENTION

This patent application asserts application of a spot-mixture of nanoparticles in bar-coding of information for security and protection. ID encoding and subsequent readout is made using the distinctive spectral features of the spot-mixture of nanoparticles defined as a tiny, invisible spot made up of absorbing and fluorescent nanoparticles whose spectral properties will be used for security ID signatures. These types of nanoparticles are commonly referred to as quantum dots; they can be either semiconductor or rare-earth. Also, they possess narrow absorption and emission bands in the visible and near-infrared parts of the spectrum. The narrowness of the peaks allows for the possibility to use their individual absorption/emission characteristics as distinct fluorescent bar-coding signatures. Therefore the combination of various types of nanoparticles allows for multiple readout peaks which substantially increases the amount of encoded information. Moreover, the amount of encoded information can be increased further by varying the concentrations of nanoparticles in the mixture. The spot-mixtures with different concentrations of nanoparticles add differentiation by absorbed/emitted intensities of each type of nanoparticle.

The readout of the encoded information can be done using a special device equipped with an excitation source and detector. The device can be based either on a broad-band or laser-like, narrow band excitation method. The former method uses the broad-band excitation source and can be also employed for differentiation by intensities. The high resolution of the readout of this method outshines its relatively slow speed of operation. It is intended for applications in which larger amount of information needs to be stored. The alternative method provides a fast way for readout and is based on a narrowband, laser-like source of excitation. The readout devices designed for both methods could be made portable.

The nanoparticles-based ID system can be implemented by depositing microsized droplets of defined combination of nanoparticles in a spot-mixture on an object or effectively, tagging the object. The nanoparticles can be either pre-mixed or deposited sequentially. The unique combination of fluorescent colors of the nanoparticles gives a characteristic fingerprint of each spot-mixture. The readout of the encoded “sign” means taking the spectral parameters of the spot.

The primary application areas of spot-size mixtures of nanoparticles are combating counterfeited items and providing security protection for materials and items of choice. The spot-mixture's small size makes it invisible thus creating ‘hidden labeling’ of the items of choice. This technology can be used on pharmaceutical products, diamonds, jewelry, art, currency bills, clothing, id tags/cards, and on any other physical object that requires unique identification.

What is claimed is:

1. A method of identification of any physical item through the unique ID signature of nanoparticles encoded on said item.

2. The method of claim 1 where rare-earth quantum dot nanoparticle absorption method is used for ID signature encoding based on identifying the absorption spectrum of the nanoparticles as the signature.

3. The method of claim 1 where rare-earth quantum dot nanoparticles emission method is used for ID signature encoding based on identifying the fluorescent emission spectrum of the nanoparticles as the signature.

4. The method of claim 1 where semiconductor quantum dot nanoparticle absorption method is used for ID signature encoding based on identifying the absorption spectrum of the nanoparticles as the signature.

5. The method of claim 1 where semiconductor quantum dot nanoparticles emission method is used for ID signature encoding based on identifying the fluorescent emission spectrum of the nanoparticles as the signature.

6. Any combination of one or more of claim 2, claim 3, claim 4, and/or claim 5 used for encoding information.

7. A method of detection for fast read-out from a spot-like mixture of nanoparticles based on consecutive excitation of the spot with different laser sources where intensities of the sources serve as the item's signature and said detection can be performed for either absorption or emission.

8. A method of detection for sensitive read-out from the mixture of nanoparticles based on a single excitation with a broadband white light source and subsequent high resolution readout.

9. A device performing the method described in claim 7

10. A device performing the method described in claim 8

11. The method of claim 6 where said nanoparticles are deposited onto any surface

12. The method of claim 6 where said nanoparticles are embedded within an object during its manufacture
